(19) United States
(12) Patent Application Publication
(10) Pub. No.: US 2017/0166772 A1
(43) Pub. Date: Jun. 15, 2017

(54) PROCESSES FOR COATING SUBSTRATES WITH POLYMERS FORMED FROM TRANS-1,3,3,3-TETRAFLUOROPROPENE AND VINYLIDENE DIFLUORIDE

(71) Applicant: HONEYWELL INTERNATIONAL INC., Morris Plains, NJ (US)

(72) Inventors: David Nalewajek, West Seneca, NY (US); Andrew Joseph Poss, Kenmore, NY (US)

(21) Appl. No.: 15/370,386

(22) Filed: Dec. 6, 2016

Related U.S. Application Data
(60) Provisional application No. 62/265,347, filed on Dec. 9, 2015.

(51) Int. Cl. C09D 127/12; B05D 3/00; B05D 1/28; B05D 1/18; B05D 1/02; C09D 5/16; B05D 1/00

(52) U.S. Cl. CPC C09D 127/12; C09D 5/1681; B05D 3/002; B05D 1/005; B05D 1/18; B05D 1/02; B05D 1/28; B05D 3/007

(57) ABSTRACT

The present invention generally relates to processes for coating substrates, preferably metals, with solutions having fluoro-copolymers that comprise trans-1,3,3,3-tetrafluoropropene monomers and vinylidene difluoride monomers and at least 50 weight percent of the fluoro-copolymer comprises trans-1,3,3,3-tetrafluoropropene monomers. The fluoro-copolymer has a surface energy below about 40 mJ/m². The surfaces of the substrates may be subjected to a phosphate treatment prior to application of the fluoro-copolymer coating, and/or the fluoro-copolymer coating may be applied directly onto the surface of the substrate.

This application claims the benefit of U.S. Application Ser. No. 62/265,347, filed Dec. 9, 2015, which is incorporated herein in its entirety.

### FIELD OF THE INVENTION

The present invention generally relates to fluoro-copolymers of trans-1,3,3,3-tetrafluoropropene and vinylidene difluoride monomers, and to various compositions and processes for applying coatings comprising the fluoro-copolymers, and to substrates coated with fluoro-copolymer coatings.

### BACKGROUND OF THE INVENTION

Biofouling is an undesirable accumulation and growth of living matter on wetted surfaces. It is a significant, world-wide problem in almost all industries that involve water-based processes, including pulp and paper manufacturing, food, underwater constructions, ship building, fish farming, and water desalination, for example.

One method of preventing biofouling is the use of non-toxic coatings that create hydrophobic surfaces to which micro-organisms cannot attach. Fluoropolymers are generally considered useful for preventing biofouling because of their non-stick and friction-reducing properties.

A polymer for use in protecting against biofouling desirably has a surface energy below 40 mJ/m². Research has shown that the optimal surface energy for resistance to biofouling in marine environments is between 20 mJ/m² and 30 mJ/m². See J. Mater. Sci:Mater. Med. (2006) 17:1057-1062.

Low surface energy polymer coatings may also be useful in applications requiring corrosion resistance.

Some fluoropolymers have a surface energy below 40 mJ/m². For example, polytetrafluoroethylene (PTFE) has a surface energy below 20 mJ/m². Another conventional fluoropolymer, polyvinylidene difluoride (PVDF) has a surface energy of about 30 mJ/m² or higher.

However, fluoropolymers are very difficult to adhere to substrates. If the surface of the substrate is not properly conditioned prior to the application of PTFE, the PTFE will not properly adhere to the substrate, resulting in an uneven coating, or one that is easily removed. Consequently, special conditioning processes and/or polymeric primer or base coats have been developed in order to adhere the fluoropolymers to the surface of various substrates. Generally, the substrate is subjected to a surface roughening treatment, such as sand blasting or grit blasting. A coating is then applied to the surface of the substrate. The coating generally includes a primer coating, a top coating, and one or more intermediate coatings. The primer coating generally contains a heat resistant organic binder and one or more fluoropolymer resins, as well as various pigments and fillers. The intermediate coatings contain mainly fluoropolymers with some pigments, fillers, and coalescing aids. The top coating is almost entirely made of fluoropolymers. The coated substrate is then heated at high temperatures in the range of 340° C. to 450° C. for 1-30 min. In some processes, there is a low temperature heating step (150° C. or less) before the high temperature heating step. Coating systems for multilayer fluoropolymer coatings are described in U.S. Pat. Nos. 7,462,667, 5,160,791, 5,230,961, 5,223,343, and 5,168,107, for example. A single layer coating process is described in CA 887,122. The coating may include a polyamide or polyamide-imide with the fluoropolymer. After the coating mixture is applied to the substrate, the coated substrate is heated at 650° F.-800° F. (343° C.-427° C.).

However, these multistep processes are complicated. They are also expensive because they require the use of expensive fluoropolymers in the primer layer as well as the intermediate layer. In addition, the high temperature heating step increases the energy usage of the process.

Another problem involves the solubility of fluoropolymers. Some fluoropolymers are either totally insoluble or have low solubility in the solvents or carriers used in coating processes. For example, PTFE polymers are insoluble in all solvents. Because of the lack of solubility, when PTFE is applied to a substrate as a coating, it is provided as a dispersion of powder particles in an aqueous carrier. The use of an aqueous carrier is advantageous for environmental and safety reasons. However, it may not be practical to use in some common coating processes because of the need to remove the aqueous carrier while maintaining an even or proper distribution of the polymer particles on the substrate. For example, when an aqueous dispersion is used in coating processes such as spraying, pouring, brushing, or other similar processes, an aqueous dispersion may not provide a uniform coating because the water may collect or bead before evaporating, causing uneven application on the surface.

Some other fluoropolymers exhibit limited solubility in a few solvents. For example, PVDF is slightly soluble (about 5-10%) in N-methyl pyrrolidone, dimethylacetamide, tetramethyl urea, dimethyl sulfoxide, triethyl phosphate, and dimethylformamide. However, the use of these solvents is undesirable due to high boiling point, toxicity, and/or carcinogenicity. PVDF is not soluble in ethanol, methanol, or cis- or trans-1-chloro-3,3,3-trifluoropropene. Various methods of applying PVDF as a coating to a substrate have been investigated in the art. Many PVDF coatings also use multilayer coating processes to obtain adequate adhesion, as described in for example, U.S. Pat. Nos. 4,379,885 and 6,500,565. A process for coating a single layer PVDF-containing coating on a metal substrate is described in U.S. Pat. No. 7,399,533. The coating, which includes PVDF resin, acrylic resin, and polyepoxide resin either dissolved or dispersed in a solvent, is applied to the surface, and heated at high temperature. For example, a temperature of 180° C. for 10 min is generally adequate for spray coatings based on PVDF homopolymers. With the roll or dip coating processes, a temperature as high as 350° C. for often no more than 50 sec can be used.

There remains a need for less complicated and less energy intensive processes for applying low surface energy fluoropolymers to substrates. There is also a need for processes utilizing environmentally friendly solvents.

### SUMMARY OF THE INVENTION

The present invention relates generally to coatings comprising fluoro-copolymers comprising trans-1,3,3,3-tetrafluoropropene (CF3CH═CHF) monomers and vinylidene difluoride (CH₂═CF₂, VDF) monomers, to substrates having surfaces protected by the coatings, and to methods of providing protective coatings on substrates.

One aspect of the invention is a process for applying a coating to a surface of a metal substrate. The process involves applying a coating solution directly to the surface of the metal substrate. The coating solution comprises a fluoro-copolymer dissolved in a solvent. The concentration of the fluoro-copolymer in the coating solution is from about 1 to about 50 weight percent. The fluoro-copolymer comprises trans-1,3,3,3-tetrafluoropropene monomers and vinylidene difluoride monomers, wherein at least 50 wt. % of the fluoro-copolymer comprises trans-1,3,3,3-tetrafluoropropene monomers. The fluoro-copolymer has a surface energy below about 40 mJ/m².

Another aspect of the invention is a process for applying a coating to a surface of a metal substrate. The process involves pretreating the surface with a metal phosphate solution. A coating solution is applied to the pretreated surface. The coating solution comprises a fluoro-copolymer dissolved in a solvent. The concentration of the fluoro-copolymer in the coating solution is from about 1 to about 50 weight percent. The fluoro-copolymer comprises trans-1,3,3,3-tetrafluoropropene monomers and vinylidene difluoride monomers, wherein at least 50 wt. % of the fluoro-copolymer comprises trans-1,3,3,3-tetrafluoropropene monomers. The fluoro-copolymer has a surface energy below about 40 mJ/m².

Another aspect of the invention is a coated substrate made by the process described.

Another aspect of the invention is a coating solution. The coating solution includes from about 1 to about 50 wt. % fluoro-copolymer in a solvent. The fluoro-copolymer comprises trans-1,3,3,3-tetrafluoropropene monomers and vinylidene difluoride monomers and at least 50 wt. % of the fluoro-copolymer comprises trans-1,3,3,3-tetrafluoropropene monomers, and the fluoro-copolymer has a surface energy below about 40 mJ/m². The solvent comprises ethanol, methanol, cis- or trans-1-chloro-3,3,3-trifluoropropene, or mixtures thereof.

### DETAILED DESCRIPTION OF THE INVENTION

Applicants have surprisingly found that high quality fluoropolymer coatings can be achieved on substrates, such as metal substrates, without the application of primer and intermediate coatings containing organic binders and fluoropolymers, and without a high temperature heating step. In some embodiments, the coating solution can use low point and/or low VOC (volatile organic compounds) solvents.

The process is simple and inexpensive. In some embodiments, a coating solution comprising a fluoro-copolymer dissolved in a solvent is applied directly to a metal substrate. The fluoro-copolymer comprises trans-1,3,3,3-tetrafluoropropene monomers and vinylidene difluoride monomers, wherein at least 50 wt. % of the fluoro-copolymer comprises trans-1,3,3,3-tetrafluoropropene monomers. As used herein, the term “substrate” refers to any device or article, or part of a device or article, to be coated. By “directly,” we mean that there is no coating or layer applied to the substrate before the coating containing the fluoro-copolymer.

In other embodiments, the metal substrate may be pretreated with a phosphate solution before applying the fluoro-copolymer solution.

The coating has excellent adherence to the metal substrate, particularly when the substrate is used under water or in other relatively corrosive environment for extended periods of time.

The coating process has a number of advantages over current processes. The process is much less complicated because fewer steps are involved. This leads to an increased production rate. Furthermore, the materials used for the pretreatment step are less expensive than the primer and intermediate coatings of the prior art, which contain fluoropolymers. In addition, the fluoro-copolymer permits the use of environmentally friendly solvents. Furthermore, the lower temperature heating step uses less energy than the prior art high temperature heating step.

### The Fluoro-Copolymer

The fluoro-copolymer comprises trans-1,3,3,3-tetrafluoropropene and vinylidene difluoride monomers. The trans-1,3,3,3-tetrafluoropropene comprises at least 50 wt % of the monomers of the fluoro-copolymer. The fluoro-copolymer has a surface energy below about 40 mJ/m².

In some embodiments, the trans-1,3,3,3-tetrafluoropropene monomers comprise from about 50 to about 70 wt % of the monomers of the fluoro-copolymer, or from about 55 to about 65 wt % of the monomers of the fluoro-copolymer, or from about 58 to about 62 wt % of the monomers of the fluoro-copolymer, or about 60 wt % of the monomers of the fluoro-copolymer. In some embodiments, the vinylidene difluoride monomers comprise from about 30 to about 50 wt % of the monomers of the fluoro-copolymer, or from about 35 to about 45 wt % of the monomers of the fluoro-copolymer, or from about 38 to about 42 wt % of the monomers of the fluoro-copolymer, or about 40 wt % of the monomers of the fluoro-copolymer. In some embodiments, the fluoro-copolymer comprises trans-1,3,3,3-tetrafluoropropene and vinylidene difluoride monomers in a 60/40 weight ratio. In some embodiments, the fluoro-copolymer used in the present invention consists essentially of the above weight percentages of trans-1,3,3,3-tetrafluoropropene monomers and vinylidene difluoride monomers. In some embodiments, the fluoro-copolymer used in the present invention consists of the above weight percentages of trans-1,3,3,3-tetrafluoropropene monomers and vinylidene difluoride monomers.

The fluoro-copolymer may contain small levels of other components, typically impurities. In any or all embodiments, the fluoro-copolymer may comprise no more than 1 wt % of any other components or monomers, for example, monomers other than trans-1,3,3,3-tetrafluoropropene and vinylidene difluoride.

The fluoro-copolymer may have a surface energy below about 40 mJ/m², or below about 30 mJ/m², or in the range of about 20 mJ/m² to about 30 mJ/m² measured according to ASTM D7490-13. The low surface energy fluoro-copolymer is beneficial in various applications including preventing biofouling, and resisting corrosion.

The fluoro-copolymer may have a weight average molecular weight in the range of about 100,000 Daltons to about 1,500,000 Daltons. Weight average molecular weight is measured by gel phase chromatography (GPC) according to the method described in Skoog, Principles of Instrumental Analysis, 6th Ed., Chapter 28, Thompson Brooks/Cole, Belmont CA, 2006. The weight average molecular weight was measured on a GPC instrument from Agilient Technologies PL-GPC-220, using Polymer Labs gel 10 mm mixed C 300×7.5 mm columns at 50° C. using polystyrene and polymethylmethacrylate standards. The calibration range is over the weight average molecular weight range of 1000 to 2 million Daltons. The sample size is 10 mg of polymer dissolved in 2 ml of tetrahydrofuran.

### Fluoro-Copolymer Manufacturing

The fluoro-copolymers used in the coatings according to the present invention may be formed using one or a combination of different applications and techniques known in the art. For example, fluoro-copolymers may be formed using one or a combination of several preferred techniques, including, (1) emulsion polymerization; (2) solution or suspension polymerization; (3) supercritical carbon dioxide polymerization; (4) stereoselective polymerization; (5) transition metal catalyzed polymerization; (6) radiation or thermal polymerization; and combinations thereof. A detailed description of such methods is disclosed in U.S. Patent Publication Nos. 2013-0089671 A1 and 2013-009049 A1, which are hereby incorporated herein by reference in their entirety.

### The Substrate

The fluoro-copolymers described herein may be applied to a variety of substrates. Exemplarily substrates include metal substrates, for example, carbon steel, stainless steel, chromium-columbium (aka chromium-niobium) corrosion-resistant steel, galvanized metals like hot-dipped galvanized steel, copper, copper alloys, aluminum, and aluminum alloys.

Some metal substrates, such as carbon steel, corrosion resistant steel, galvanized steel, copper, copper alloys, aluminum, and aluminum alloys, may have an oxide layer on the surface. The surface of the substrate is intended to include the metal oxide layers as being part of the substrate. In other words, the coating or the phosphate solution can be applied to the oxide layer; the oxide layer does not need to be removed.

### Optional Cleaning Step

The substrate may be cleaned with various cleaners or solvents to remove any debris, such as dirt, lubricating oil, or other unwanted surface material. Suitable cleaners are known in the art and include, but are not limited to, alcohols, ketones and esters. Suitable alcohols include methanol, ethanol, and isopropanol. After cleaning, the substrate may be rinsed with water or alcohol, for example. The optional cleaning step may take place before the fluoro-copolymer coating step. If the optional roughening step is performed, the cleaning step may be performed after the optional roughening step. If the phosphate pretreatment is used, the cleaning step may be performed before the phosphate pretreatment step.

### Optional Roughening Step

In some embodiments, the surface of the substrate may be subjected to a process to provide a roughened surface such as a blasting procedure, like grit blasting or sand blasting, if desired. These processes, which are known in the art, can be used to clean the surface of the substrate and/or to provide a surface roughness to the substrate. However, it is not believed that a specified surface roughness is needed for acceptable adhesion of the coating to the substrate. If the surface roughening step is performed, there will typically be a cleaning step after the surface roughening step.

### Phosphate Pretreatment Step

In some embodiments, the surface of the substrate may be pretreated with a metal phosphate solution. The pretreatment process may increase the overall adhesion between the surface and the coating. The metal phosphate solution may be a zinc phosphate solution or an iron phosphate solution.

Processes utilizing metal phosphate solutions may involve dissolving a metal, such as iron or zinc, in phosphoric acid. The resulting metal phosphate solution is applied to the surface of the substrate by, for example, spray or immersion coating processes which are known in the art. In addition to dissolving or otherwise removing debris and soil, the metal phosphate solution will produce a layer of metal phosphate on the surface of the substrate as a result of the reaction of the metal from the substrate and the phosphate in the solution. After neutralizing and/or rinsing the treated surface of the substrate, the substrate may be dried. The metal phosphate solution typically contains about 1 wt % to about 50 wt % zinc or iron phosphate in phosphoric acid, or about 1 wt % to about 45 wt %, or about 1 wt % to about 40 wt %, or about 1 wt % to about 35 wt %, or about 1 wt % to about 30 wt %, or about 5 wt % to about 50 wt %, or about 5 wt % to about 45 wt %, or about 5 wt % to about 40 wt %, or about 5 wt % to about 35 wt %, or about 5 wt % to about 30 wt %, or about 10 wt % to about 50 wt %, or about 10 wt % to about 45 wt %, or about 10 wt % to about 35 wt %, or about 10 wt % to about 30 wt %.

In some embodiments, the zinc phosphate solution can include about 10 wt % to about 30 wt % zinc bis(dihydrogen phosphate), about 5 wt % to about 10 wt % phosphoric acid, about 5 wt % to about 10 wt % zinc nitrate, about 3 wt % to about 7 wt % manganese bis(dihydrogen phosphate), and about 1 wt % to about 5 wt % nickel dehydrate, with the remainder being water.

In some embodiments, the iron phosphate solution can include about 10 wt % to about 30 wt % iron phosphate, about 1 wt % to about 5 wt % hydroxylamine sulfate, about 1 wt % to about 5 wt % sodium 3-nitrobenzenesulphonate, about 1 wt % to about 5 wt % sodium xylene sulfonate, about 0.1 wt % to about 1 wt % sodium fluoride, and about 0.1 wt % to about 1 wt % sodium tetrafluoroborate.

The substrate is typically immersed in the metal phosphate solution for about 30 sec to about 1 hr, or about 30 sec to about 45 min, or about 30 sec to about 30 min, or about 30 sec to about 15 min, or about 30 sec to about 10 min, or about 30 sec to about 5 min, or about 1 min to about 30 min, or about 1 min to about 15 min, or about 1 min to about 10 min, or about 1 min to about 5 min.

During application, the metal phosphate solution is typically maintained at a temperature of about 20° C. to about 100° C., or about 20° C. to about 80° C., or about 20° C. to about 70° C., or about 20° C. to about 60° C., or about 30° C. to about 80° C., or about 30° C. to about 70° C., or about 30° C. to about 60° C., or about 40° C. to about 80° C., or about 40° C. to about 70° C., or about 40° C. to about 60° C.

Phosphate pretreatment may be particularly advantageous for chromium-columbium (aka chromium-niobium) corrosion-resistant steel.

With respect to some substrates, for example, stainless steel, the coating may be directly applied to the substrate surface without the phosphate pretreatment.

### The Fluoro-Copolymer Coating Solution

The fluoro-copolymers and, optionally, additives may be dissolved in a solution with an organic solvent or mixture of solvents. Applicants have found that fluoro-copolymers formed from trans-1,3,3,3-tetrafluoropropene and vinylidene difluoride monomers are soluble in a larger selection of solvents compared to other fluoropolymers. Some of these additional solvents are more environmentally friendly than the solvents traditionally used with other fluoropolymers.

The solvent may be, but is not required to be, a polar solvent, either protic or aprotic. Suitable solvents include, but are not limited to, ethyl acetate, acetone, cis- or trans-1-chloro-3,3,3-trifluoropropene (HFO-1233zd), tetrahydrofuran, dimethylformamide, dimethylsulfoxide, dimethylacetamide, 1,1,1,3,3-pentafluorobutane, N-methyl pyrrolidone, ethanol, methanol, 1,3-dioxolane, or mixtures thereof.

Some of the solvents are lower boiling point solvents, which may allow certain temperature sensitive substrates to be coated without damage to the substrate as a result of the high evaporation temperature required to remove the solvent. Low boiling point solvents generally have a boiling point of less than about 130° C., or less than about 120° C., or less than about 110° C., or less than about 100° C., or less than about 90° C., or less than about 80° C., or less than about 70° C., or less than about 60° C.

Some of the solvents are low volatile organic compounds (VOC) solvents, such as hydrofluoroolefins, such as cis- or trans-1-chloro-3,3,3-trifluoropropene.

The use of ethanol, methanol, and cis- or trans-1-chloro-3,3,3-trifluoropropene is advantageous because these solvents, are generally safer and/or more environmentally friendly compared to other solvents because they have lower boiling points, and/or are less toxic or carcinogenic. Additionally, these solvents allow the fluoro-copolymers to be applied in easier and more cost effective application processes like spraying, dip coating, and spin-on coating. Furthermore, no high temperature heating step is required. The ability to use these solvents can lower production costs and improve the overall coating process. For example, using cis- or trans-1-chloro-3,3,3-trifluoropropene will allow the solvent to be evaporated into the surrounding atmosphere without the safety and environmental concerns that arise with solvents such as tetrahydrofuran, dimethylformamide, dimethylsulfoxide, or N-methyl pyrrolidone.

The amount of solvent used to form a coating solution including the fluoro-copolymers can be varied so that the fluoro-copolymer concentration can range from about 1 to about 50 wt. % of the solution, or from about 1 to about 40 wt. %, or from about 1 to about 30 wt. %, or from about 1 to about 25 wt. %, or from about 1 to about 20 wt. %, or from about 1 to about 15 wt. %, or from about 1 to about 10 wt. %, or from about 3 to about 50 wt. %, or from about 3 to about 40 wt. %, or from about 3 to about 30 wt. %, or from about 3 to about 25 wt. %, or from about 3 to about 20 wt. %, or from about 3 to about 15 wt. %, or from about 3 to about 10 wt. %, or from about 5 to about 50 wt. %, or from about 5 to about 40 wt. %, or from about 5 to about 30 wt. %, or from about 5 to about 25 wt. %, or from about 5 to about 20 wt. %, or from about 5 to about 15 wt. %, or from about 5 to about 10 wt. %, or from about 7 to about 50 wt. %, or from about 7 to about 40 wt. %, or from about 7 to about 30 wt. %, or from about 7 to about 25 wt. %, or from about 7 to about 20 wt. %, or from about 7 to about 15 wt. %, or from about 10 to about 50 wt. %, or from about 10 to about 40 wt. %, or from about 10 to about 30 wt. %, or from about 10 to about 25 wt. %, or from about 10 to about 20 wt. %, or from about 10 to about 15 wt. %, or from about 15 to about 50 wt. %, or from about 15 to about 40 wt. %, or from about 15 to about 30 wt. %, or from about 15 to about 25 wt. %, or from about 20 to about 50 wt. %, or from about 20 to about 40 wt. %, or from about 20 to about 30 wt. %. As will be appreciated, the fluoro-copolymers amounts may be varied depending upon the application method and/or performance requirements.

Depending on the use, the coating solution of the present invention may include one or more additives. The additives may be provided to improve one or more characteristics of the fluoro-copolymers coating composition. By way of non-limiting example, silica and/or silica- or carbon-based nanoparticles may be provided to change surface energy and refractive index of the composition. Additional additives may be provided to assist with insulation of the coating, anti-corrosion, with hydrophobicity, therapeutic effects, substrate bonding or adhesion, or the like. Some additives may be added to increase the porosity of the fluoropolymers. Suitable additives may include, but are not limited to, high- or low-temperature additives, fillers, pigments saturants, lubricants, tackifiers, adhesion promoters, film-formers, thickeners, processing aids, electrically conductive materials, electrically insulative materials, stabilizers, impact modifiers, viscosity modifiers, or any other additive that improves one or more of the properties herein or which is otherwise compatible with the fluoropolymers. One of skill in the art will appreciate, however, that the present invention is not limited to such additives generally or with each composition and that these or any composition of the present invention may be modified to include one or more additives otherwise known or may be useful for the purpose provided. Typically, the final coating comprises no more than about 25 wt. % of the additives, or no more than about 20 wt. %, or no more than 15 about wt. %, or no more than about 10 wt. %, or no more than about 5 wt. %, or no more than about 1 wt. % of the additives.

In some embodiments, there may be manufacturing advantages to forming a concentrated coating solution, then diluting it to the desired coating concentration. In alternate embodiments, dilution could occur prior to or during the initial mixing stage.

### The Coating Process

The coating solutions including the fluoro-copolymers can be applied directly to the surface of the substrate using standard coating processes known in the art including, but not limited to dip coating, spin-on coating, slot die coating, spraying, pouring, rolling, brushing, or other coating techniques. By “applied directly to the surface” we mean that the coating solution is applied to the untreated surface of the substrate (including the surface oxide layer if present) or to the phosphate treated surface of the substrate. No primer or intermediate coatings containing fluoropolymers and organic binders or other adhesive layers are applied to the surface of the substrate before the fluoro-copolymer solution is applied.

The temperature of the fluoro-copolymer coating solution is typically in the range of about 20° C. to about 100° C., or about 20° C. to about 90° C., or about 20° C. to about 80° C., or about 20° C. to about 70° C., or about 20° C. to about 60° C., or about 20° C. to about 50° C., or about 20° C. to about 40° C., or about 20° C. to about 30° C., or about 20° C. to about 25° C.

The substrate is typically immersed in the fluoro-copolymer coating solution for about 30 sec to about 1 hr, or about 30 sec to about 45 min, or about 30 sec to about 30 min, or about 30 sec to about 15 min, or about 30 sec to about 10 min, or about 30 sec to about 5 min, or about 1 min to about 30 min, or about 1 min to about 15 min, or about 1 min to about 10 min, or about 1 min to about 5 min. For other processes, the application time is the length of time needed to obtain an even coating.

### Post-Treatment

After application, the solvent in the coating may be removed, for example by drying or simply allowing the solvent to evaporate at ambient conditions or at elevated temperatures, depending in part upon the solvent used and the time needed to allow the fluoro-copolymers to cure and form the coating. In solutions with a low VOC solvent, the evaporation of the solvent can be accomplished without releasing VOCs into the atmosphere. In solutions using low boiling point solvents, less energy may be required to remove the solvent from the coating solution than would be required if higher boiling point solvents were used.

The time for drying depends on the substrate, the method of coating, and the method of drying. For example, a spin-coated substrate may be dried in about 1 min, while a dip coated substrate may be dried in about 30 min to about 1 hr. The drying time generally ranges from about 1 minute to about 12 hours, or about 1 minute to about 10 hours, or about 1 minute to about 8 hours, or about 1 minute to about 6 hours, or about 1 minute to about 5 hours, or about 1 minute to about 4 hours, or about 1 minute to about 3 hours, or about 1 minute to about 2 hours, or about 1 minute to about 1 hour, or about 1 minute to about 45 minutes, or about 1 minute to about 30 minutes, or about 1 minute to about 15 minutes, or about 10 minute to about 1 hour, or about 10 minute to about 45 minutes, or about 10 minute to about 30 minutes, or about 10 minute to about 15 minutes. The temperature may range from about ambient temperature to about 150° C., or from about 50° C. to about 150° C., or from about 100° C. to about 150° C. One of ordinary skill in the art will appreciate that allowing the solvent to evaporate may be accomplished at a variety of processing conditions and thus, these conditions are merely exemplary.

In some embodiments, after the solvent has evaporated, the fluoro-copolymer coating is formed directly on the surface of the substrate. In other embodiments, the fluoro-copolymer coating is formed on the phosphate layer on the surface of the substrate.

The dried coating composition may comprise at least about 90 wt. % fluoro-copolymers, or at least about 95 wt. %, or at least about 97 wt. %, or at least about 98 wt. %, or at least about 99 wt. %.

The coating has excellent adhesion to the surface of the substrate. In some embodiments, the coating may have an adhesion pull-off strength to a metal substrate of at least about 100 psi, or at least about 150 psi, or at least about 200 psi, or at least about 250 psi, or at least about 300 psi, or at least about 350 psi, or at least about 400 psi, or at least about 450 psi, or at least about 500 psi, or at least about 550 psi, or at least about 600 psi, or at least about 650 psi, or at least about 700 psi, or at least about 750 psi, or at least about 800 psi, or at least about 850 psi, or at least about 900 psi. The pull-off strength adhesion was measured according to ASTM 4541-09, Annex A-3, Method D, Type IV Test Apparatus. The adhesion tester was a SEMicro Model Quantum Gold PATTI Adhesion Tester (LEQP 0194). The piston size was F-20 (F-8 range) for the copper substrate, and F-1 for the aluminum and steel substrates. The pull stub size was 20.0 mm. The bonding glue was 3M Scotch-Weld® Adhesive DP-400, and the cure time was 72 hr. The load rate was approximately 1-5 psi/sec. The evaluation was for adhesion strength and failure mode.

In some embodiments, the metal substrate is pretreated by immersion in a zinc phosphate or iron phosphate solution for about 2 min. The zinc or iron phosphate solution contains about 1 wt % to about 50 wt % zinc or iron phosphate in water. The phosphate solution may be at a temperature of about 125° C. The phosphate treated substrate may be dried at ambient temperature.

The fluoro-copolymer coating solution contains a fluoro-copolymer comprising trans-1,3,3,3-tetrafluoropropene and vinylidene difluoride monomers in a 60/40 weight ratio having a weight average molecular weight of 100,000 to 1,500,000 Daltons and a surface energy in the range of in the range of about 20 mJ/m² to about 30 mJ/m². The solvent may be one or more of methanol, ethanol, and as cis- or trans-1-chloro-3,3,3-trifluoropropene. The concentration of the fluoro-copolymer in the solvent is about 1 wt % to about 10 wt %. The fluoro-copolymer coating solution is at a temperature of about 20° C. to about 25° C.

The metal substrate is immersed in the fluoro-copolymer coating solution for about 1 min to about 10 min. The coated substrate is dried at a temperature of about 100° C. to about 150° C. for about 10 min to about 1 hr. The immersion and drying steps may be repeated.

### Aspects of the Invention

Aspects of the invention are provided below.

Aspect 1: a coating comprising from about 1 to about 50 wt. % fluoro-copolymer, wherein the fluoro-copolymer comprises trans-1,3,3,3-tetrafluoropropene monomers and vinylidene difluoride monomers and at least 50 wt. % of the fluoro-copolymer comprises trans-1,3,3,3-tetrafluoropropene monomers, and the fluoro-copolymer has a surface energy below about 40 mJ/m².

Aspect 2: the coating composition according to aspect 1, wherein the trans-1,3,3,3-tetrafluoropropene monomers comprise from about 50 to about 70 wt % of the monomers of the fluoro-copolymer.

Aspect 3: the coating composition according to aspect 1, wherein the trans-1,3,3,3-tetrafluoropropene monomers comprise from about 55 to about 65 wt % of the monomers of the fluoro-copolymer.

Aspect 4: the coating composition according to aspect 1, wherein the trans-1,3,3,3-tetrafluoropropene monomers comprise or from about 58 to about 62 wt % of the monomers of the fluoro-copolymer.

Aspect 5: the coating composition according to aspect 1, wherein the trans-1,3,3,3-tetrafluoropropene monomers comprise or about 60 wt % of the monomers of the fluoro-copolymer.

Aspect 6: the coating composition according to any of aspects 1 to 5, wherein the vinylidene difluoride monomers comprise from about 30 to about 50 wt % of the monomers of the fluoro-copolymer.

Aspect 7: the coating composition according to any of aspects 1 to 5, wherein the vinylidene difluoride monomers comprise from about 35 to about 45 wt % of the monomers of the fluoro-copolymer.

Aspect 8: the coating composition according to any of aspects 1 to 5, wherein the vinylidene difluoride monomers comprise from about 38 to about 42 wt % of the monomers of the fluoro-copolymer.

Aspect 9: the coating composition according to any of aspects 1 to 5, wherein the vinylidene difluoride monomers comprise about 40 wt % of the monomers of the fluoro-copolymer.

Aspect 10: the coating composition according to aspect 1, wherein the fluoro-copolymer comprises trans-1,3,3,3-tetrafluoropropene and vinylidene difluoride monomers in a 60/40 weight ratio.

Aspect 11: the coating composition according to any of aspects 1 to 10 wherein the fluoro-copolymer has a surface energy below about 30 mJ/m².

Aspect 12: the coating composition according to any of aspects 1 to 11, wherein the fluoro-copolymer has a surface energy or in the range of about 20 mJ/m² to about 30 mJ/m².

Aspect 13: the coating composition according to any of aspects 1 to 12, wherein the fluoro-copolymer has a weight average molecular weight in the range of about 100,000 Daltons to about 1,500,000 Daltons.

Aspect 14: the coating composition according to any of aspects 1 to 13, wherein the composition comprises a solvent.

Aspect 15: the coating composition according to aspect 14, wherein the solvent comprises ethanol, methanol, cis- or trans-1-chloro-3,3,3-trifluoropropene, or mixtures thereof.

Aspect 16: the coating composition according to any of aspects 1 to 15, wherein the coating solution contains at least one additive.

Aspect 17: the coating composition according to aspect 16, wherein the additive is selected from silica nanoparticles, silica based nanoparticles, carbon based nanoparticles, high-temperature additives, low-temperature additives, fillers, pigments, saturants, lubricants, tackifiers, adhesion promoters, film-formers, thickeners, processing aids, electrically conductive materials, electrically insulative materials, stabilizers, impact modifiers, viscosity modifiers, and combinations thereof

Aspect 18: a process for applying a coating to a surface of a metal substrate, the process comprising:

applying a coating solution directly to the surface of the metal substrate, wherein the coating solution comprises a fluoro-copolymer dissolved in a solvent, wherein a concentration of the fluoro-copolymer in the coating solution is from about 1 to about 50 weight percent, wherein the fluoro-copolymer comprises trans-1,3,3,3-tetrafluoropropene monomers and vinylidene difluoride monomers, wherein at least 50 wt. % of the fluoro-copolymer comprises trans-1,3,3,3-tetrafluoropropene monomers, and wherein the fluoro-copolymer has a surface energy below about 40 mJ/m².

Aspect 19: the process according to aspect 18, further comprising pretreating the surface of the metal substrate with a metal phosphate solution before applying the coating solution.

Aspect 20: the process of according to aspect 18 or 19, wherein the metal phosphate solution comprises zinc phosphate or iron phosphate.

Aspect 21: the process according to any one of aspects 19 to 20, wherein the metal phosphate solution has a concentration of about 1 wt % to about 50 wt % metal phosphate.

Aspect 22: the process according to any one of aspects 18 to 21, wherein the solvent is selected from the group consisting of: ethyl acetate; acetone; cis- or trans-1-chloro-3,3,3-trifluoropropene; tetrahydrofuran; dimethylformamide; dimethylsulfoxide; dimethylacetamide; 1,1,1,3,3-pentafluorobutane; N-methyl pyrolidinone; ethanol; methanol; 1,3-dioxolane; and mixtures thereof.

Aspect 23: the process according to any one of aspects 18 to 22, wherein the solvent is selected from the group consisting of: cis- or trans-1-chloro-3,3,3-trifluoropropene; ethanol; methanol; and mixtures thereof.

Aspect 24: the process of according to any one of claims 18 to 23, wherein the coating solution contains at least one additive.

Aspect 25: the process according to aspect 24, wherein the additive is selected from silica nanoparticles, silica based nanoparticles, carbon based nanoparticles, high-temperature additives, low-temperature additives, fillers, pigments, saturants, lubricants, tackifiers, adhesion promoters, film-formers, thickeners, processing aids, electrically conductive materials, electrically insulative materials, stabilizers, impact modifiers, viscosity modifiers, and combinations thereof

Aspect 26: the process according to any one of aspects 18 to 25, wherein the coating solution is applied to the treated surface by one or more of dip coating, spin-on coating, slot die coating, spraying, pouring, rolling, and brushing.

Aspect 27: the process according to any one of aspects 18 to 26, further comprising: cleaning the metal substrate before applying the coating solution.

Aspect 28: the process according to any one of aspects 18 to 27, further comprising: evaporating the solvent after applying the coating solution to provide a coated surface.

Aspect 29: the process according to any one of aspects 18 to 28, wherein the metal substrate comprises carbon steel, stainless steel, chromium-columbium corrosion-resistant steel, galvanized steel, copper, copper alloy, aluminum, aluminum alloys, and combinations thereof.

Aspect 30: the process according to any one of aspects 18 to 29, wherein the metal substrate has a metal oxide layer thereon, and wherein the coating solution is applied over the metal oxide layer.

Aspect 31: the process according to any one of aspects 18 to 30, further comprising applying a surface roughening treatment to the metal substrate before applying the coating solution.

Aspect 32: the process of according to any one of aspects 18 to 31, wherein the fluoro-copolymer comprises from about 50 to about 70 wt. % trans-1,3,3,3-tetrafluoropropene monomers.

Aspect 33: the process of according to any one of aspects 18 to 32, wherein the fluoro-copolymer comprises from about 65 to about 55 wt. % trans-1,3,3,3-tetrafluoropropene monomers.

Aspect 34: the process of according to any one of aspects 18 to 33, wherein the fluoro-copolymer comprises from about 62 to about 58 wt. % trans-1,3,3,3-tetrafluoropropene monomers.

Aspect 35: the process of according to any one of aspects 18 to 34, wherein the fluoro-copolymer consists of 60 wt. % trans-1,3,3,3-tetrafluoropropene monomers and 40 wt. % vinylidene difluoride monomers.

Aspect 36: the process of according to any one of aspects 18 to 35, wherein the vinylidene difluoride monomers comprise from about 30 to about 50 wt % of the monomers of the fluoro-copolymer.

Aspect 37: the coating composition according to any of aspects 18 to 36, wherein the vinylidene difluoride monomers comprise from about 35 to about 45 wt % of the monomers of the fluoro-copolymer.

Aspect 38: the coating composition according to any of aspects 18 to 37, wherein the vinylidene difluoride monomers comprise from about 38 to about 42 wt % of the monomers of the fluoro-copolymer.

Aspect 39: the coating composition according to any of aspects 18 to 38, wherein the vinylidene difluoride monomers comprise about 40 wt % of the monomers of the fluoro-copolymer.

Aspect 40: the coating composition according to any one of aspects 18 to 39, wherein the fluoro-copolymer comprises trans-1,3,3,3-tetrafluoropropene and vinylidene difluoride monomers in a 60/40 weight ratio.

Aspect 41: a process for applying a coating to a surface of a metal substrate, the process comprising:

pretreating the surface with a metal phosphate solution; and

applying a coating solution to the pretreated surface, the coating solution comprising a fluoro-copolymer dissolved in a solvent, wherein a concentration of the fluoro-copolymer in the coating solution is from about 1 to about 50 weight percent, wherein the fluoro-copolymer comprises trans-1,3,3,3-tetrafluoropropene monomers and vinylidene difluoride monomers, wherein at least 50 wt. % of the fluoro-copolymer comprises trans-1,3,3,3-tetrafluoropropene monomers, and wherein the fluoro-copolymer has a surface energy below about 40 mJ/m².

Aspect 42: the process according to aspect 41, wherein the metal phosphate solution comprises zinc phosphate or iron phosphate.

Aspect 43: the process according to any one of aspects 41 or 42, wherein the metal phosphate solution has a concentration of about 1 wt % to about 50 wt % metal phosphate.

Aspect 44: the process according to any one of aspects 41 to 43, wherein the solvent is selected from the group consisting of: ethyl acetate; acetone; cis- or trans-1-chloro-3,3,3-trifluoropropene; tetrahydrofuran; dimethylformamide; dimethylsulfoxide; dimethylacetamide; 1,1,1,3,3-pentafluorobutane; N-methyl pyrolidinone; ethanol; methanol; 1,3-dioxolane; and mixtures thereof.

Aspect 45: the process according to any one of aspects 41 to 44, wherein the solvent is selected from the group consisting of: cis- or trans-1-chloro-3,3,3-trifluoropropene; ethanol; methanol; and mixtures thereof.

Aspect 46: the process according to any one of aspects 41 to 45, wherein the coating solution contains at least one additive.

Aspect 47: the process according to any one of aspects 41 to 46, wherein the additive is selected from silica nanoparticles, silica based nanoparticles, carbon based nanoparticles, high-temperature additives, low-temperature additives, fillers, pigments, saturants, lubricants, tackifiers, adhesion promoters, film-formers, thickeners, processing aids, electrically conductive materials, electrically insulative materials, stabilizers, impact modifiers, viscosity modifiers, and combinations thereof

Aspect 48: the process according to any one of aspects 41 to 47, wherein the coating solution is applied to the treated surface by one or more of dip coating, spin-on coating, slot die coating, spraying, pouring, rolling, and brushing.

Aspect 49: the process according to any one of aspects 41 to 48, further comprising: cleaning the metal substrate before applying the coating solution.

Aspect 50: the process according to any one of aspects 41 to 49, further comprising: evaporating the solvent after applying the coating solution to provide a coated surface.

Aspect 51: the process according to any one of aspects 41 to 50, wherein the metal substrate comprises carbon steel, stainless steel, chromium-columbium corrosion-resistant steel, galvanized steel, copper, copper alloy, aluminum, aluminum alloys, and combinations thereof.

Aspect 52: the process according to any one of aspects 41 to 51, wherein the metal substrate has a metal oxide layer thereon, and wherein the coating solution is applied over the metal oxide layer.

Aspect 53: the process according to any one of aspects 41 to 52, further comprising applying a surface roughening treatment to the metal substrate before applying the coating solution.

Aspect 54: the process according to any one of aspects 41 to 53, wherein the fluoro-copolymer comprises from about 50 to about 70 wt. % trans-1,3,3,3-tetrafluoropropene monomers.

Aspect 55: the process according to any one of aspects 41 to 54, wherein the fluoro-copolymer comprises from about 55 to about 56 wt. % trans-1,3,3,3-tetrafluoropropene monomers.

Aspect 56: the process according to any one of aspects 41 to 55, copolymer comprises from about 58 to about 62 wt. % trans-1,3,3,3-tetrafluoropropene monomers.

Aspect 57: the process according to any one of aspects 41 to 56, wherein the vinylidene difluoride monomers comprise from about 30 to about 50 wt % of the monomers of the fluoro-copolymer.

Aspect 58: the coating composition according to any of aspects 41 to 57, wherein the vinylidene difluoride monomers comprise from about 35 to about 45 wt % of the monomers of the fluoro-copolymer.

Aspect 59: the coating composition according to any of aspects 41 to 58, wherein the vinylidene difluoride monomers comprise from about 38 to about 42 wt % of the monomers of the fluoro-copolymer.

Aspect 60: the coating composition according to any of aspects 41 to 59, wherein the vinylidene difluoride monomers comprise about 40 wt % of the monomers of the fluoro-copolymer.

Aspect 61: the coating composition according to any one of aspects 41 to 60, wherein the fluoro-copolymer comprises trans-1,3,3,3-tetrafluoropropene and vinylidene difluoride monomers in a 60/40 weight ratio.

Aspect 62: the coating composition according to any one of aspects 41 to 61, wherein the fluoro-copolymer consists of 60 wt. % trans-1,3,3,3-tetrafluoropropene monomers and 40 wt. % vinylidene difluoride monomers.

Aspect 63: a coated substrate made using the process according to any one of claims 18-62.

One of skill in the art will readily appreciate that the present invention is not limited to the foregoing description and that the following specific EXAMPLES of the fluoro-copolymers and how they may be used are merely exemplary. Throughout this application, any of the fluoro-copolymers described for any specific uses are intended to be exemplary and may be used in any of the other uses described herein and any fluoro-copolymers described generally may be used in any of the specific uses as described herein.

### EXAMPLES

### Polymer Synthesis

2700 ml of a solution containing 30.49 g (0.114 mol) of Na₂HPO₄. 7H₂O, 8.9 g (0.074 mol) of NaH₂PO₄, 4.45 g (0.0199 mol) of (NH₄)₂S₂O₈ and 30 g (0.069 mol) of C₇F₁₅CO₂NH₄ was added to a 2-gallon autoclave. The solution was cooled to about 5° C. 1500 g (13.16 mol) of trans-1,3,3,3-tetrafluoropropene (HFO-1234ze) was added, followed by the addition of 1000 g (15.63 mol) vinylidene difluoride (VF2).

7.5 g (0.0395 mol) of Na₂S₂O₅ dissolved in 50 ml H₂O was added at a rate of 5 ml/min. After the addition was complete, the reactor temperature was raised to 35° C. and maintained at that temperature for 7 days. The reactor was cooled 25° C., and the unreacted monomers were removed. The aqueous solution was drained from the reactor and diluted with an equal volume of H₂O. With constant stirring, 100 ml HCl (37%) was added to induce precipitation of the polymer over about 3 hrs. The resulting white solid was stirred for 2 hours, filtered, and washed with deionized (DI) water until the filtrate was neutral. After drying at 35° C. at ≦10 mm Hg, 1027 g (48 yield %) of the copolymer was obtained. Analysis by NMR gave a composition of 60 wt % 1234ze/40 wt % VF2. The product had a weight average molecular weight of 1 million Daltons as determined by GPC analysis as described above.

### Coating Composition

In the following EXAMPLES 1A to 6C, a fluoro-copolymer coating composition of the present invention was made which contained: (a) 25 grams of fluoro-copolymer comprising about 60 wt. % trans-1,3,3,3-tetrafluoropropene monomers and 40 wt. % of vinylidene difluoride monomers; and (b) about 475 grams of ethyl acetate. The resulting concentration of the fluoro-copolymer was 5 wt. %. The average molecular weight of the fluoro-copolymers as determined by GPC as described above was about 510,000 Daltons.

### Example 1A—Corrosion Resistant Steel—Zinc Phosphate Treatment

An untreated corrosion resistant steel coupon chromium-columbium (chromium-niobium) steel, available from ACT Test Panel Technologies of Hillsdale, Mich. measuring 4 in.×12 in.×2 mils was provided. The untreated coupon was sprayed with a cleaning solution (PPG CK163LF cleaning solution available from PPG Industries) at a temperature of 54° C. (130° F.) for 60 sec. It was rinsed with water at a temperature of 38° C. (100° F.) for 60 sec, followed by immersion in a rinse conditioner (PPG rinse conditioner available from PPG Industries) at ambient temperature for 60 sec. It was then immersed in a zinc phosphate solution (Chemfil® C700, available from Chemfil, Windsor Ontario, Canada) at 52° C. (125° F.) for 120 sec. The coupon was then rinsed with water at ambient temperature for 30 sec, immersed in Chemseal 59 (available from PPG Industries) for a final rinse at ambient temperature for 30 sec, rinsed with water at ambient temperature for 30 sec, and dried at ambient temperature.

The pretreated coupon was then dipped horizontally at room temperature into the fluoro-copolymer coating solution described above until it was completely immersed. The coupon was removed after being completely immersed and allowed to dry at room temperature vertically for one hour. The coupon was placed vertically in an oven at a temperature of about 100° C. and heated for about 30 minutes after the oven reached the set temperature. The coupon was cooled to room temperature. The dipping and heating steps were repeated once to provide a coated coupon.

The coated coupon was completely immersed at the bottom of a fresh water aquarium containing biological debris and live guppies which was maintained at room temperature. After 5 days, no delamination of the coating from the coated coupon was observed. Further, no delamination of the coating from the coated coupon was observed after 1, 3, and 6 months.

### Example 1B—Corrosion Resistant Steel—No Phosphate Treatment

A second untreated corrosion resistant steel coupon chromium-columbium (chromium-niobium) steel, available from ACT Test Panel Technologies of Hillsdale, Mich. was provided. The coupon was not pretreated with any phosphate pretreatment.

The second corrosion resistant steel coupon was coated with the coating solution described above, using the same steps and the same conditions as EXAMPLE 1A.

The coated coupon was completely immersed at the bottom of a fresh water aquarium containing biological debris and live guppies which was maintained at room temperature. After 5 days, the coating had delaminated from the coated coupon.

Thus, the methods of the present invention produce an unexpected significantly superior result in terms of adhesion achieved by the fluoro-copolymer coating when the substrate is treated with a phosphate treatment.

### Example 2A—Corrosion Resistant Steel—No Phosphate Treatment

A corrosion resistant steel coupon chromium-columbium (chromium-niobium) steel, available from ACT Test Panel Technologies of Hillsdale, Mich. measuring 4 in.×12 in.×2 mils was provided. The coupon was not pretreated with any phosphate pretreatment.

The corrosion resistant steel coupon was coated with the coating solution described above, using the same steps and the same conditions as EXAMPLE 1A. The coating was allowed to cure to form a coated coupon which was tested to determine the adhesion of the coating to the coupon. The results of the testing are shown in TABLE 1.

### Example 2B—Corrosion Resistant Steel—Iron Phosphate Treatment

Another corrosion resistant steel coupon chromium-columbium (chromium-niobium) steel, available from ACT Test Panel Technologies of Hillsdale, Mich. was provided. An iron phosphate treatment solution (Bonderite 1070, available from Henkel Corporation, of Dusseldorf, Germany) was provided under ambient conditions, and the coupon was pretreated with the iron phosphate in the same manner as described above for zinc phosphate.

After the phosphate treatment, the coupon was then coated with the coating solution described above, using the same steps and the same conditions as EXAMPLE 1A. The coating was allowed to cure to form a coated coupon which was tested to determine the adhesion of the coating to the coupon. The results of the testing are shown in TABLE 1.

### Example 2C—Corrosion Resistant Steel—Zinc Phosphate Treatment

Another corrosion resistant steel coupon chromium-columbium (chromium-niobium) steel, available from ACT Test Panel Technologies of Hillsdale, Mich. was provided. A zinc phosphate pretreatment (Chemfil® C700, available from Chemfil, Windsor Ontario, Canada) was provided under ambient conditions, and the coupon was treated with the zinc phosphate as described above.

After the phosphate treatment, the coupon was then coated with the coating solution described above, using the same steps and the same conditions as EXAMPLE 1A. The coated coupon was tested to determine the adhesion of the coating to the coupon. The results of the testing are shown in TABLE 1 with the results from EXAMPLE 2A being provided for comparison purposes:

TABLE 1

| | EX. 2A | EX. 2B | EX. 2C |
|---|---|---|---|
| Adhesion (Cross Cut Test)* | 0B¹ | 5B² | 5B² |
| Adhesion (Pull-off | 86.1 psi | 631.1 psi | 953.2 psi |
| Strength)** | | | |

*ASTM D 3359-09 Method B. The scribing tool was an Olfa knife, with a 1.0 mm blade spacing template, and three adhesions per sample.
**ASTM D 4541-09 Annex A-3, Method D, Type IV Test Apparatus as described above.
¹0B-Flaking and detachment worse than Grade 1.
²5B-The edges of the cuts are completely smooth; none of the squares of the lattice is detached.

As can be seen from the above, the methods of the present invention produce unexpectedly superior results in terms of the level of adhesion achieved by the fluoro-copolymer coating when the substrate is corrosion-resistant steel treated with iron phosphate or zinc phosphate prior to the fluoro-copolymer coating step. More specifically, the level of adhesion with iron phosphate pretreatment is more than ten times better than the level of adhesion achieved on untreated corrosion resistant steel with iron phosphate pretreatment. The improved adhesion between the substrate and the coating was achieved without requiring the application of primer and intermediate coatings containing organic binders and fluoropolymers and without high temperature heating.

### Example 3A—Aluminum Alloy—No Treatment

An aluminum alloy coupon (ALM 3003, available from ACT Test Panel Technologies of Hillsdale, Mich.) measuring 4 in.×12 in.×2 mils was provided. The coupon was not pretreated with any phosphate pretreatment.

The aluminum alloy coupon was then coated with the coating solution described above, using the same steps and the same conditions as EXAMPLE 1A. The coating was allowed to cure to form a coated coupon which was tested to determine the adhesion of the coating to the coupon. The results of the testing are shown in TABLE 2.

### Example 3B—Aluminum Alloy—Iron Phosphate Treatment

Another aluminum alloy coupon (ALM 3003, available from ACT Test Panel Technologies of Hillsdale, Mich.) was provided. An iron phosphate pretreatment solution (Bonderite 1070, available from Henkel Corporation, of Dusseldorf, Germany) was provided under ambient conditions, and the coupon was treated with the iron phosphate in the same manner as described above for zinc phosphate.

After the phosphate treatment, the coupon was then coated with the coating solution described above, using the same steps and the same conditions as EXAMPLE 1A. The coating was allowed to cure to form a coated coupon which was tested to determine the adhesion of the coating to the coupon. The results of the testing are shown in TABLE 2.

### Example 3C—Aluminum Alloy—Zinc Phosphate Treatment

Another aluminum alloy coupon (ALM 3003, available from ACT Test Panel Technologies of Hillsdale, Mich.) was provided. A zinc phosphate pretreatment (Chemfil® C700, available from Chemfil, Windsor Ontario, Canada) was provided under ambient conditions, and the coupon was treated with the zinc phosphate as described above.

After the phosphate treatment, the coupon was then coated with the coating solution described above, using the same steps and the same conditions as EXAMPLE 1A. The coated coupon was tested to determine the adhesion of the coating to the coupon. The results of the testing are shown in TABLE 2.

TABLE 2

| | EX. 3A | EX. 3B | EX. 3C |
|---|---|---|---|
| Adhesion (Cross Cut Test)* | 0B¹ | 5B² | 5B² |
| Adhesion (Pull-off | 31.2 psi | 252.1 psi | 247.9 psi |
| Strength)** | | | |

*ASTM D 3359-09 Method B as described above.
¹0B-Flaking and detachment worse than Grade 1.
²5B-The edges of the cuts are completely smooth; none of the squares of the lattice is detached.
**ASTM D 4541-09 Annex A-3, Method D, Type IV Test Apparatus as described above.

As can be seen from the above results of EXAMPLES 3A, 3B, and 3C, the level of adhesion on the aluminum alloy treated with either iron or zinc phosphate is about eight times the better than the level of adhesion on the untreated aluminum alloy.

### Example 4A—Hot Dip Galvanized Steel—No Treatment

A hot dip galvanized steel coupon (ALM 3003, available from ACT Test Panel Technologies of Hillsdale, Mich.) measuring 4 in.×12 in.×2 mils was provided. The coupon was not pretreated with any phosphate pretreatment.

The hot dip galvanized steel coupon was then coated with the coating solution described above, using the same steps and the same conditions as EXAMPLE 1A. The coating was allowed to cure to form a coated coupon which was tested to determine the adhesion of the coating to the coupon. The results of the testing are shown in TABLE 3.

### Example 4B—Hot Dip Galvanized Steel—Iron Phosphate Treatment

A hot dip galvanized steel coupon (available from ACT Test Panel Technologies of Hillsdale, Mich.) was provided. An iron phosphate pretreatment solution (Bonderite 1070, available from Henkel Corporation, of Dusseldorf, Germany) was provided under ambient conditions, and the coupon was treated with the iron phosphate in the same manner as described above for zinc phosphate.

After the phosphate treatment, the coupon was then coated with the coating solution described above, using the same steps and the same conditions as EXAMPLE 1A. The coating was allowed to cure to form a coated coupon which was tested to determine the adhesion of the coating to the coupon. The results of the testing are shown in TABLE 3.

### Example 4C—Hot Dip Galvanized Steel—Zinc Phosphate Treatment

Another hot dip galvanized steel coupon (available from ACT Test Panel Technologies of Hillsdale, Mich.) was provided. A zinc phosphate pretreatment (Chemfil® C700, available from Chemfil, Windsor Ontario, Canada) was provided under ambient conditions, and the coupon was treated with the zinc phosphate as described above.

After the phosphate treatment, the coupon was then coated with the coating solution described above, using the same steps and the same conditions as EXAMPLE 1A. The coated coupon was tested to determine the adhesion of the coating to the coupon. The results of the testing are shown in TABLE 3.

TABLE 3

| | EX. 4A | EX. 4B | EX. 4C |
|---|---|---|---|
| Adhesion (Cross Cut Test)* | 0B¹ | 5B² | 5B² |
| Adhesion (Pull-off | 60.9 psi | 138.9 psi | 592.2 psi |
| Strength)** | | | |

*ASTM D 3359-09 Method B as described above.
¹0B-Flaking and detachment worse than Grade 1.
²5B-The edges of the cuts are completely smooth; none of the squares of the lattice is detached.
**ASTM D 4541-09 Annex A-3, Method D, Type IV Test Apparatus as described above.

As can be seen from the above results of EXAMPLES 4A, 4B, and 4C, the level of adhesion on the hot dip galvanized steel treated with iron phosphate prior to the coating step is more than twice the level of adhesion on the untreated hot dip galvanized steel, and the level of adhesion on the untreated hot dip galvanized steel treated with zinc phosphate is almost ten times the level of adhesion on the untreated hot dip galvanized steel.

### Example 5A—Copper Alloy—No Treatment

A copper alloy coupon (ALM 3003, available from ACT Test Panel Technologies of Hillsdale, Mich.) measuring 4 in.×12 in.×2 mils was provided. The coupon was not pretreated with any phosphate pretreatment.

The copper alloy coupon was then coated with the coating solution described above, using the same steps and the same conditions as EXAMPLE 1A. The coating was allowed to cure to form a coated coupon which was tested to determine the adhesion of the coating to the coupon. The results of the testing are shown in TABLE 4.

### Example 5B—Copper Alloy—Iron Phosphate Treatment

Another copper alloy coupon (110, available from ACT Test Panel Technologies of Hillsdale, Mich.) was provided. An iron phosphate pretreatment solution (Bonderite 1070, available from Henkel Corporation, of Dusseldorf, Germany) was provided under ambient conditions, and the coupon was treated with the iron phosphate in the same manner as described above for zinc phosphate.

After the phosphate treatment, the coupon was then coated with the coating solution described above, using the same steps and the same conditions as EXAMPLE 1A. The coating was allowed to cure to form a coated coupon which was tested to determine the adhesion of the coating to the coupon. The results of the testing are shown in TABLE 4.

### Example 5C—Copper Alloy—Zinc Phosphate Treatment

Another copper alloy coupon (110, available from ACT Test Panel Technologies of Hillsdale, Mich.) was provided. A zinc phosphate pretreatment (Chemfil® C700, available from Chemfil, Windsor Ontario, Canada) was provided under ambient conditions, and the coupon was treated with the zinc phosphate as described above.

After the phosphate treatment, the coupon was then coated with the coating solution described above, using the same steps and the same conditions as EXAMPLE 1A. The coated coupon was tested to determine the adhesion of the coating to the coupon. The results of the testing are shown in TABLE 4.

TABLE 4

| | EX. 5A | EX. 5B | EX. 5C |
|---|---|---|---|
| Adhesion (Cross Cut Test)* | 5B² | 5B² | 5B² |
| Adhesion (Pull-off | 251 psi | 464.3 psi | 112.5 psi |
| Strength)** | | | |

*ASTM D 3359-09 Method B as described above.
²5B-The edges of the cuts are completely smooth; none of the squares of the lattice is detached.
**ASTM D 4541-09 Annex A-3, Method D, Type IV Test Apparatus as described above.

As can be seen from the results of EXAMPLES 5A, 5B, and 5C, the level of adhesion on the copper alloy treated with iron phosphate prior to the fluoro-copolymer coating step is more than 1.5 times the level of adhesion of the untreated copper alloy. The level of adhesion on the copper alloy treated with either zinc phosphate is less than half of the level of adhesion of the untreated copper alloy.

### Example 6A—Stainless Steel—No Treatment

A stainless steel coupon (SS-316, available from ACT Test Panel Technologies of Hillsdale, Mich.) measuring 4 in.×12 in.×2 mils was provided. The coupon was not pretreated with any phosphate pretreatment.

The untreated coupon was coated with the coating solution described above, using the same steps and the same conditions as EXAMPLE 1A. The coated coupon was tested to determine the adhesion of the coating to the coupon. The results of the testing are shown in TABLE 5.

### Example 6B—Stainless Steel—Iron Phosphate Treatment

A second stainless steel coupon (SS-316, available from ACT Test Panel Technologies of Hillsdale, Mich.) was provided. An iron phosphate pretreatment solution (Bonderite 1070, available from Henkel Corporation, of Dusseldorf, Germany) was provided under ambient conditions, and the coupon was treated with the iron phosphate in the same manner as described above for zinc phosphate.

After the phosphate treatment, the coupon was then coated with the coating solution described above, using the same steps and the same conditions as EXAMPLE 1A. The coating was allowed to cure to form a coated coupon which was tested to determine the adhesion of the coating to the coupon. The results of the testing are shown in TABLE 5.

### Example 6C—Stainless Steel—Zinc Phosphate Treatment

A third stainless steel coupon (SS-316, available from ACT Test Panel Technologies of Hillsdale, Mich.) was provided. A zinc phosphate pretreatment (Chemfil® C700, available from Chemfil, Windsor Ontario, Canada) was provided under ambient conditions, and the third coupon was treated with the zinc phosphate as described above.

After the phosphate treatment, the coupon was then coated with the coating solution described above, using the same steps and the same conditions as EXAMPLE 1A. The coated coupon was tested to determine the adhesion of the coating to the coupon. The results of the testing are shown in TABLE 5.

TABLE 5

| | EX. 6A | EX. 6B | EX. 6C |
|---|---|---|---|
| Adhesion (Cross Cut | 5B² | 5B² | 5B² |
| Test)* | | | |
| Adhesion (Pull-off | 586.5 psi | 280.1 psi | 597.3 psi |
| Strength)** | | | |

*ASTM D 3359-09 Method B as described above.
²5B-The edges of the cuts are completely smooth; none of the squares of the lattice is detached
**ASTM D 4541-09 Annex A3, Method D, Type IV Test Apparatus as described above.

As can be seen from the above, the level of adhesion is about the same for stainless steel treated with zinc phosphate compared to stainless steel which was not treated with phosphate. The level of adhesion achieved for the stainless steel treated with the iron phosphate is about half the level obtained with untreated stainless steel.

In the foregoing EXAMPLES, a final thickness of the coatings on the substrates was found to range between 0.1 to 0.3 mils (0.00254 to 0.00762 mm) with an average thickness being between 0.12 to 0.14 mm. The coating thickness was measured according to ASTM D 7091-13 using an Elcometer Model 456T (LEQP 0311). The thickness reported is an average of six readings.

### Example 7

A coating composition of the present invention was made with: (a) 25 grams of the fluoro-copolymer described above comprising about 60 wt. % trans-1,3,3,3-tetrafluoropropene monomers and 40 wt. % of vinylidene difluoride monomers; and (b) about 475 grams of methanol. The fluoro-copolymer concentration was 5 wt. %.

We repeat Examples 2A-6C using this fluoro-copolymer coating solution and zinc and iron phosphate treatments and find that the coatings have improved adhesion to the metal substrates.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions.

In the foregoing, all temperatures are set forth in degrees Celsius and, all parts and percentages are by weight, unless otherwise indicated.

As used herein, the singular forms “a,” “an” and “the” include plural unless the context clearly dictates otherwise. Moreover, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

From the foregoing, it will be appreciated that although specific examples have been described herein for purposes of illustration, various modifications may be made without deviating from the spirit or scope of this disclosure. It is therefore intended that the foregoing detailed description be regarded as illustrative rather than limiting, and that it be understood that it is the following claims, including all equivalents, that are intended to particularly point out and distinctly claim the claimed subject matter.

What is claimed is:

1. A process for applying a coating to a surface of a metal substrate, the process comprising:
applying a coating solution directly to the surface of the metal substrate, the coating solution comprising a fluoro-copolymer dissolved in a solvent, wherein a concentration of the fluoro-copolymer in the coating solution is from about 1 to about 50 weight percent, wherein the fluoro-copolymer comprises trans-1,3,3,3-tetrafluoropropene monomers and vinylidene difluoride monomers, wherein at least 50 wt. % of the fluoro-copolymer comprises trans-1,3,3,3-tetrafluoropropene monomers, and wherein the fluoro-copolymer has a surface energy below about 40 mJ/m².

2. The process of claim 1, further comprising pretreating the surface with a metal phosphate solution before applying the coating solution.

3. The process of claim 2, wherein the metal phosphate solution comprises zinc phosphate or iron phosphate.

4. The process of claim 3, wherein the metal phosphate solution has a concentration of about 1 wt % to about 50 wt % metal phosphate.

5. The process of claim, wherein the solvent is selected from the group consisting of: ethyl acetate; acetone; cis- or trans-1-chloro-3,3,3-trifluoropropene; tetrahydrofuran; dimethylformamide; dimethylsulfoxide; dimethylacetamide; 1,1,1,3,3-pentafluorobutane; N-methyl pyrolidinone; ethanol; methanol; 1,3-dioxolane; and mixtures thereof.

6. The process of claim 5, wherein the solvent is selected from the group consisting of: cis- or trans-1-chloro-3,3,3-trifluoropropene; ethanol; methanol; and mixtures thereof.

7. The process of claim 1, wherein the coating solution contains at least one additive.

8. The process of claim 7, wherein the additive is selected from silica nanoparticles, silica based nanoparticles, carbon based nanoparticles, high-temperature additives, low-temperature additives, fillers, pigments, saturants, lubricants, tackifiers, adhesion promoters, film-formers, thickeners, processing aids, electrically conductive materials, electrically insulative materials, stabilizers, impact modifiers, viscosity modifiers, and combinations thereof.

9. The process of claim 1, wherein the coating solution is applied to the metal substrate by one or more of dip coating, spin-on coating, slot die coating, spraying, pouring, rolling, and brushing.

10. The process claim 1, further comprising cleaning the metal substrate before applying the coating solution.

11. The process of claim 1, further comprising evaporating the solvent after applying the coating solution to provide a coated surface.

12. The process of claim 1, wherein the metal substrate comprises carbon steel, stainless steel, chromium-columbium (chromium-niobium) corrosion-resistant steel, galvanized steel, copper, copper alloy, aluminum, aluminum alloys, and combinations thereof.

13. The process of claim 1, wherein the metal substrate has a metal oxide layer thereon, and wherein the coating solution is applied over the metal oxide layer.

14. The process of claim 1, further comprising applying a surface roughening treatment to the metal substrate before applying the coating solution.

15. The process of claim 1, wherein the fluoro-copolymer comprises from about 50 to about 70 wt. % trans-1,3,3,3-tetrafluoropropene monomers.

16. The process of claim 1, wherein the fluoro-copolymer comprises from about 55 to about 65 wt. % trans-1,3,3,3-tetrafluoropropene monomers.

17. The process of claim 1, wherein the fluoro-copolymer comprises from about 58 to about 62 wt. % trans-1,3,3,3-tetrafluoropropene monomers.

18. The process of claim 1, wherein the fluoro-copolymer consists of about 60 wt. % trans-1,3,3,3-tetrafluoropropene monomers and about 40 wt. % vinylidene difluoride monomers.

19. A process for applying a coating to a surface of a metal substrate, the process comprising:
pretreating the surface of the metal substrate with a metal phosphate solution; and
applying a coating solution to the pretreated surface of the metal substrate,
the coating solution comprising a fluoro-copolymer dissolved in a solvent, wherein a concentration of the fluoro-copolymer in the coating solution is from about 1 to about 50 wt. %, wherein the fluoro-copolymer consists essentially of trans-1,3,3,3-tetrafluoropropene monomers and vinylidene difluoride monomers, wherein the fluoro-copolymer comprises about 50 to about 70 wt. % trans-1,3,3,3-tetrafluoropropene monomers, and wherein the fluoro-copolymer has a surface energy below about 40 mJ/m².

20. The process of claim 19 wherein the metal phosphate solution comprises zinc phosphate or iron phosphate.

21. The process of claim 19, wherein the solvent is selected from the group consisting of: ethyl acetate; acetone; cis- or trans-1-chloro-3,3,3-trifluoropropene; tetrahydrofuran; dimethylformamide; dimethylsulfoxide; dimethylacetamide; 1,1,1,3,3-pentafluorobutane; N-methyl pyrolidinone; ethanol; methanol; 1,3-dioxolane; and mixtures thereof.

22. The process of claim 21, wherein the solvent is selected from the group consisting of: cis- or trans-1-chloro-3,3,3-trifluoropropene; ethanol; methanol; and mixtures thereof.

23. The process of claim 19, wherein the coating solution is applied to the treated surface by one or more of dip coating, spin-on coating, slot die coating, spraying, pouring, rolling, and brushing.

24. The process of claim 19, wherein the metal substrate comprises carbon steel, stainless steel, chromium-columbium (chromium-niobium) corrosion-resistant steel, galvanized steel, copper, copper alloy, aluminum, aluminum alloys, and combinations thereof.

25. The process of claim 19, wherein the metal substrate has a metal oxide layer thereon, and wherein the coating solution is applied over the metal oxide layer.

26. The process of claim 19, wherein the fluoro-copolymer comprises from about 55 to about 65 wt. % trans-1,3,3,3-tetrafluoropropene monomers.

27. The process of claim 19, wherein the fluoro-copolymer comprises from about 58 to about 62 wt. % trans-1,3,3,3-tetrafluoropropene monomers.

28. The process of claim 19, wherein the fluoro-copolymer consists of 60 wt. % trans-1,3,3,3-tetrafluoropropene monomers and 40 wt. % vinylidene difluoride monomers.

29. A coating solution comprising:
from about 1 to about 50 wt. % fluoro-copolymer dissolved in a solvent, wherein the fluoro-copolymer comprises trans-1,3,3,3-tetrafluoropropene monomers and vinylidene difluoride monomers and at least 50 wt. % of the fluoro-copolymer comprises trans-1,3,3,3-tetrafluoropropene monomers, and the fluoro-copolymer has a surface energy below about 40 mJ/m², and
wherein the solvent comprises ethanol, methanol, cis- or trans-1-chloro-3,3,3-trifluoropropene, or mixtures thereof.

30. The coating solution of claim 29, wherein, the fluoro-copolymer consists essentially of trans-1,3,3,3-tetrafluoropropene monomers and vinylidene difluoride monomers and comprises from about 50 to about 70 wt. % trans-1,3,3,3-tetrafluoropropene monomers.

31. The coating solution of claim 30, wherein the fluoro-copolymer comprises from about 55 to about 65 wt. % trans-1,3,3,3-tetrafluoropropene monomers.

32. The coating solution of claim 30, wherein the fluoro-copolymer comprises from about 58 to about 62 wt. % trans-1,3,3,3-tetrafluoropropene monomers.

33. The coating solution of claim 29, wherein the fluoro-copolymer consists of 60 wt. % trans-1,3,3,3-tetrafluoropropene monomers and 40 wt. % vinylidene difluoride monomers.

34. The coating solution of claim 29, wherein the coating solution contains at least one additive.

35. The coating solution of claim 34, wherein the additive is selected from silica nanoparticles, silica based nanoparticles, carbon based nanoparticles, high-temperature additives, low-temperature additives, fillers, pigments, saturants, lubricants, tackifiers, adhesion promoters, film-formers, thickeners, processing aids, electrically conductive materials, electrically insulative materials, stabilizers, impact modifiers, viscosity modifiers, and combinations thereof.
